(19) United States
(12) Patent Application Publication
(10) Pub. No.: US 2026/0009263 A1
(43) Pub. Date: Jan. 8, 2026

(54) PADDLE SHAFT LOCKING MECHANISM FOR GATE TRANSMISSION PROTECTION

(71) Applicant: Cubic Transportation Systems, Inc., San Diego, CA (US)

(72) Inventors: Mark Barry Pottinger, Lewes (GB); Christian Cabugon, Crawley (GB)

(73) Assignee: Cubic Transportation Systems, Inc., San Diego, CA (US)

(21) Appl. No.: 19/257,364

(22) Filed: Jul. 1, 2025

Related U.S. Application Data
(60) Provisional application No. 63/667,423, filed on Jul. 3, 2024.

(51) Int. Cl. E05B 47/00; E05F 15/614; E06B 11/08

(52) U.S. Cl. CPC E05B 47/0002; E05F 15/614; E06B 11/08; E05Y 2201/22; E05Y 2201/236; E05Y 2201/246; E05Y 2201/266; E05Y 2900/402

(57) ABSTRACT

A transmission system with a protection device to enable access and damage control at a fare gate. The transmission system includes a motor, a gate paddle, and the protection device. The motor rotates a paddle shaft to drive the gate paddle. The gate paddle is operable to allow transmission through the fare gate. The protection device locks the paddle shaft in case of fare evasion at the fare gate. The protection device includes a locking mechanism integrated at the paddle shaft. The locking mechanism pulls shaft arms of the paddle shaft via a solenoid when torque applied to the paddle shaft reaches a preset threshold. The locking mechanism further locks the paddle shaft to stop rotation of the gate paddle and blocks transmission through the fare gate.

### PRIORITY

This application is a non-provisional of and claims priority to U.S. Provisional Patent Application No. 63/667,423, filed Jul. 3, 2024, the contents of which is incorporated herein by reference in its entirety.

### BACKGROUND

This disclosure relates, in general, to a transmission system and, not by way of limitation, to access and damage control at the transmission system, among other things.

Fare gates are used to regulate entry and exit of a transit system, like a metro, subway, or train station. Fare evasion is a vexing problem that poses security threats and affects the revenue of the transit system. The fare gate is operable to allow valid access efficiently, especially during peak volumes. Commuters passing through the fare gates may be accompanied by strollers, luggage, free-riding children, or various other objects. Mechanical paddles are actuated for valid commuters passing through the fare gates, with allowed objects or children.

Over time, constant use by thousands of commuters leads to mechanical degradation, causing fare gates to malfunction or operate less smoothly. This can result in longer queues, delays, and frustration among passengers. Additionally, frequent repairs and maintenance increase operational costs for transit authorities. In severe cases, compromised fare gates can lead to security vulnerabilities, allowing unauthorized access and fare evasion.

### SUMMARY

In one embodiment, the present disclosure provides a transmission system with a protection device to enable access and damage control at a fare gate. The transmission system includes a motor, a gate paddle, and the protection device. The motor rotates a paddle shaft to drive the gate paddle. The gate paddle is operable to allow transmission through the fare gate. The protection device locks the paddle shaft in case of fare evasion at the fare gate. The protection device includes a locking mechanism integrated at the paddle shaft. The locking mechanism pulls shaft arms of the paddle shaft via a solenoid when torque applied to the paddle shaft reaches a preset threshold. The locking mechanism further locks the paddle shaft to stop rotation of the gate paddle and blocks transmission through the fare gate.

In an embodiment, a transmission system with a protection device to enable access and damage control at a fare gate. The transmission system includes a motor, a gate paddle, and the protection device. The motor rotates a paddle shaft to drive the gate paddle. The gate paddle is operable to allow transmission through the fare gate. The protection device locks the paddle shaft in case of fare evasion at the fare gate. The protection device includes a locking mechanism integrated at the paddle shaft. The locking mechanism pulls shaft arms of the paddle shaft via a solenoid when torque applied to the paddle shaft reaches a preset threshold. The locking mechanism further locks the paddle shaft to stop rotation of the gate paddle and blocks transmission through the fare gate. Transmission through the fare gate is granted while the gate paddle is rotating, and transmission through the fare gate is blocked while rotation of the gate paddle is stopped. The gate paddle is connected to the paddle shaft to allow transmission at the fare gate based on rotation of the paddle shaft. Fare evasion at the fare gate occurs when the gate paddle is forcibly opened in an opposite direction, an abuse load is applied, and/or a credit is not validated at the fare gate. The protection device is activated when applied torque at the paddle shaft reaches the preset threshold. The preset threshold of the locking mechanism is based on the amount of force applied on the gate paddles. Transmission through the fare gate is allowed when the power supply to the solenoid is cut off.

In another embodiment, a transmission method with a protection device to enable access and damage control at a fare gate. In one step, the transmission method includes rotating a paddle shaft to drive a gate paddle via a motor. The gate paddle is configured to allow transmission through the fare gate. The protection device locks the paddle shaft in case of fare evasion at the fare gate. The protection device includes a locking mechanism integrated at the paddle shaft. The locking mechanism includes pulling shaft arms of the paddle shaft via a solenoid when torque applied to the paddle shaft reaches a preset threshold. The locking mechanism further includes locking the paddle shaft to stop rotation of the gate paddle and blocking transmission through the fare gate. Transmission through the fare gate is granted while the gate paddle is rotating, and transmission through the fare gate is blocked while rotation of the gate paddle is stopped. The gate paddle is connected to the paddle shaft to allow transmission at the fare gate based on rotation of the paddle shaft. Fare evasion at the fare gate occurs when the gate paddle is forcibly opened in an opposite direction, an abuse load is applied, and/or a credit is not validated at the fare gate. The protection device is activated when applied torque at the paddle shaft reaches the preset threshold. The preset threshold of the locking mechanism is based on the amount of force applied on the gate paddles. Transmission through the fare gate is allowed when the power supply to the solenoid is cut off.

In yet another embodiment, a transmission device with a protection mechanism to enable access and damage control at a fare gate. The transmission device includes a motor, a gate paddle, and the protection mechanism. The motor rotates a paddle shaft to drive the gate paddle. The gate paddle is operable to allow transmission through the fare gate. The protection mechanism locks the paddle shaft in case of fare evasion at the fare gate. The protection mechanism includes a locking mechanism integrated at the paddle shaft. The locking mechanism pulls shaft arms of the paddle shaft via a solenoid when torque applied to the paddle shaft reaches a preset threshold. The locking mechanism further locks the paddle shaft to stop rotation of the gate paddle and blocks transmission through the fare gate. Transmission through the fare gate is granted while the gate paddle is rotating, and transmission through the fare gate is blocked while rotation of the gate paddle is stopped. The gate paddle is connected to the paddle shaft to allow transmission at the fare gate based on rotation of the paddle shaft. Fare evasion at the fare gate occurs when the gate paddle is forcibly opened in an opposite direction, an abuse load is applied, and/or a credit is not validated at the fare gate. The protection mechanism is activated when applied torque at the paddle shaft reaches the preset threshold. The preset threshold of the locking mechanism is based on the amount of force applied on the gate paddles. Transmission through the fare gate is allowed when the power supply to the solenoid is cut off.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIGS. 1A-B illustrates a transmission system with a protection device to enable access and damage control at a fare gate;

FIG. 2 illustrates a planar view of the mechanical components involved in the rotation of the gate paddles of the fare gate;

FIG. 3A illustrates a planar view of a locking mechanism integrated at the paddle shaft in an unlocked state;

FIG. 3B illustrates a planar view of a locking mechanism integrated at the paddle shaft in a locked state; and

FIG. 4 illustrates a flow diagram of a transmission method with a protection device to enable access and damage control at a fare gate according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

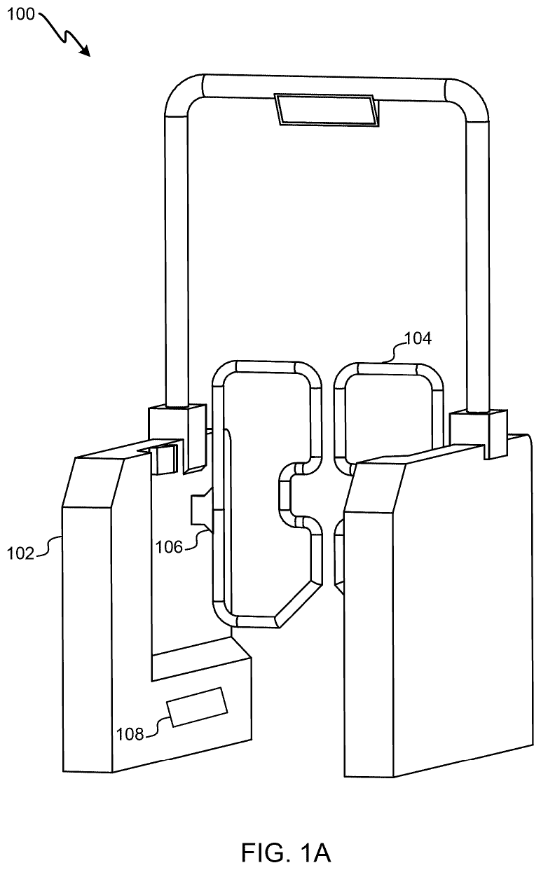

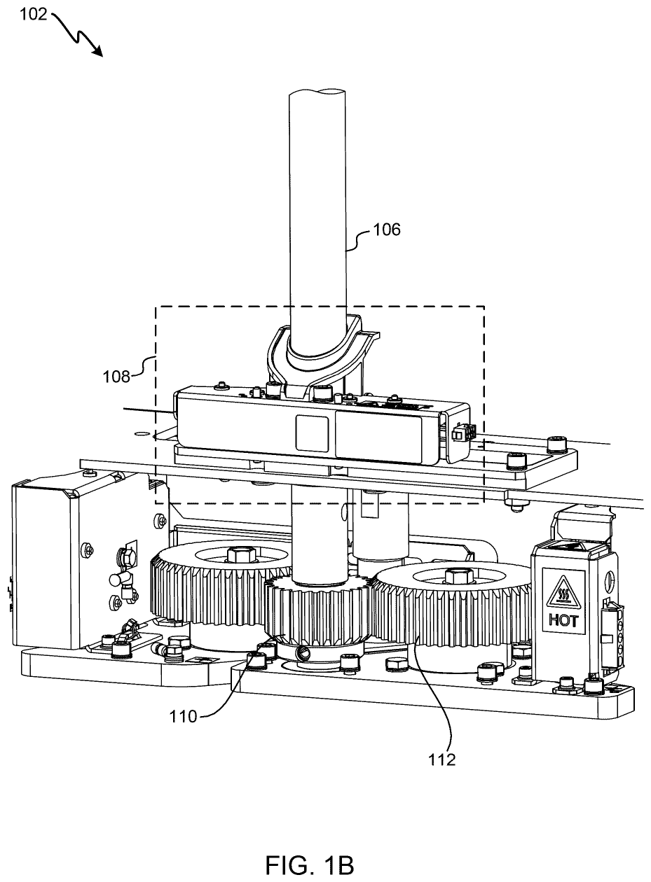

Referring to FIGS. 1A-1B, a transmission system 100 with a protection device 108 to enable access and damage control at a fare gate 102 is shown as an embodiment. The transmission system 100 includes the fare gate 102, a fundamental basic transportation system component. The fare gate 102 manages and controls passenger access to transit areas such as subway stations, bus terminals, and train platforms. The fare gate 102 works on a turnstile principle, i.e., the gate paddle unlocks when credit is presented and locks when credit is rejected or not presented. The fare gate 102 monitors passengers who have paid the fare before entering or exiting the transmission system 100, thereby helping to maintain revenue integrity and streamline passenger flow.

The fare gate 102 consists of gate paddles 104, paddle shaft 106, fare media reader, and the protection device 108 that work together to allow passage through the transmission system 100. The gate paddle 104 is the physical gate that opens and closes to allow or restrict access. The gate paddle 104 can be in the form of one or more sliding doors, rotating turnstiles, or flaps. The gate paddle 104 is connected to the corresponding paddle shaft 106 to allow transmission at the fare gate 102 based on rotation of the paddle shafts 106 of the fare gate 102. Transmission through the fare gate 102 is granted while the gate paddle 104 rotates, and transmission through the fare gate 102 is blocked while the rotation of the gate paddle 104 is stopped.

The terms “fare gate” and “fare gates” are used interchangeably throughout this description. Similarly, the terms “gate paddle” and “gate paddles”, the terms “paddle shaft” and “paddle shafts”, and the terms “shaft gear” and “shaft gears” are used interchangeably throughout this description.

The fare gate 102 further validates fare payments and controls access. When a passenger approaches a fare gate, they typically present a ticket, smart card, or mobile payment to the fare media reader integrated into the fare gate 102. The transmission system 100 then verifies the payment and, if valid, allows the fare gate 102 to open, granting access. This process helps prevent fare evasion, ensuring that only paying passengers can use the transit services. By controlling entry and exit points, the fare gates 102 help to manage crowd flow, reduce congestion, and improve overall safety within transit stations.

The fare media reader reads and validates fare media presented by passengers. The fare media reader includes radio frequency identification (RFID) readers for smart cards, barcode scanners for paper tickets, and near field communication (NFC) readers for mobile payments. The fare media reader is integrated with a central fare collection system to verify payment and authorize access. A control system manages the operation of the fare gate 102, including opening and closing the gate paddles 104, processing the fare media, and communicating with the central fare collection system.

Additionally, the fare gates 102 are equipped with sensors and detection technologies to monitor passenger behavior and detect fare evasion. These systems identify unauthorized access attempts and generate real-time alerts for transit authorities. A user interface includes displays and indicators that provide information to passengers, such as fare validation status, instructions for using the fare gate 102, and error messages. The fare gates 102 are also equipped with emergency features to ensure passenger safety during serious situations. These include the protection device 108 for emergency gate release mechanisms, access and damage control at the fare gate 102, override controls, and integration with station-wide emergency systems.

In one embodiment, an E2 wide aisle gate (WAG) is designed with a longer paddle to accommodate wider aisles, providing easier access for passengers, including those with disabilities or carrying luggage. The transmission system 100 converts the torque from the paddle shaft 106 into a motion mandatory to open and close the fare gate 102. This longer paddle of the WAG increases the torque applied at the paddle shaft 106 during operation. Under normal conditions, the increased torque does not pose any issues, and the fare gate 102 functions smoothly, ensuring efficient and accessible entry and exit for passengers. However, when an excess load is applied at the fare gate 102, the increased torque can damage the internal components of the fare gate 102 over time.

The protection device 108 of the fare gate 102 is integrated where overloading could damage the equipment and where a level of transmitted torque has to be limited. The protection device 108 protects a shaft gear 110 and a motor gear 112 by stopping the rotation of the paddle shaft 106 and halting the passenger flow through the fare gate 102. The protection device 108 also prevents fare evasion at the transmission system 100. Fare evasion occurs when the gate paddles 104 are forcibly opened in the opposite direction to allow fare evaders to pass through the gate paddle 104 without validating credit. Fare evasion also occurs when an abuse load is applied and/or a credit is not validated at the fare gate 102. The protection device 108 reduces fare evasion and prevents gear motor breakages on the E2 WAG.

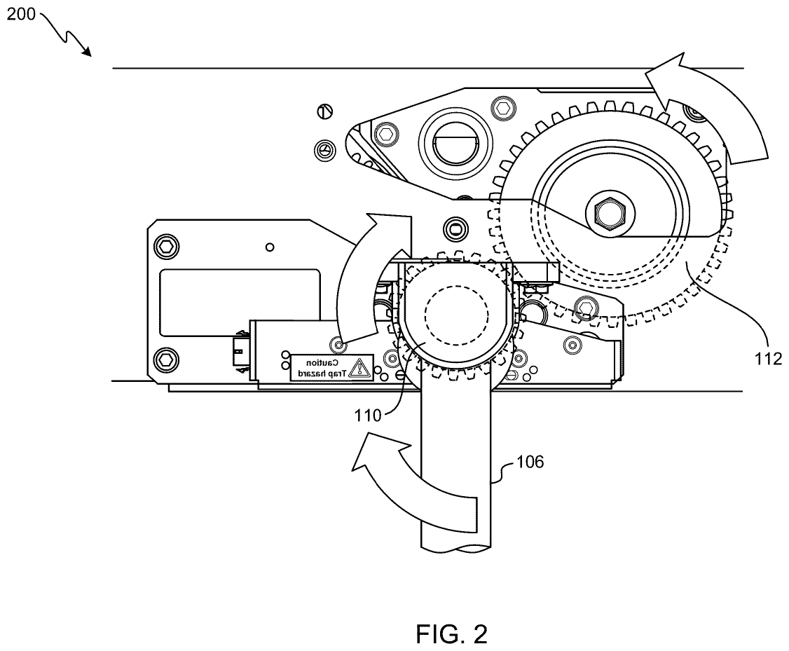

Referring next to FIG. 2, mechanical components 200 involved in the rotation of the gate paddle 104 of the fare gate 102 are shown as an embodiment. The motor gear 112, the shaft gear 110, and the paddle shaft 106 work together to control the movement of the gate paddle 104. The motor gear 112 is driven by an electric motor that serves as the primary source of motion for the transmission system 100. When the fare gate 102 is activated, i.e., the power supply is connected, the electric motor powers the motor gear 112, causing it to rotate. This rotation is the initial step in the process of moving the gate paddle 104. The motor gear 112 provides the desired torque to drive the subsequent components in the transmission system 100.

The shaft gear 110 is connected to the motor gear 112. The shaft gear 110 or the spur gear transmits the rotational motion from the motor gear 112 to the paddle shaft 106. The shaft gear 110 and the motor gear 112 are meshed, ensuring that the rotation of the motor gear 112 directly influences the rotation of the shaft gear 110. This connection is designed to be robust and precise, allowing for smooth and efficient transfer of motion. The shaft gear 110 is durable and capable of withstanding the forces exerted by the motor gear 112, especially during continuous operation in busy transit environments. The paddle shaft 106 is the component directly responsible for moving the gate paddle 104. The paddle shaft 106 is connected to the shaft gear 110, and as the shaft gear 110 rotates, the paddle shaft 106 rotates as well. The paddle shaft 106 converts the rotational motion into the movement of the gate paddle 104. This movement can be either opening or closing the fare gate 102, depending on the direction of rotation. The paddle shaft 106 is precisely aligned and securely attached to the gate paddle 104 to provide accurate and reliable operation.

The gate paddle 104 swings open or closed smoothly, providing a clear indication to passengers whether they can proceed or have to wait. The gate paddle 104 is designed to be durable enough to withstand the daily wear and tear of constant use, as well as any potential abuse loads that may be applied. The gate paddle 104 can become a point of vulnerability when subjected to abuse loads. An abuse load refers to excessive force or pressure applied to the gate, which can occur due to intentional misuse, accidental impact, or overcrowding. The abuse load applied leads to fare evasion at the fare gate 102. When such a load is applied to the extended WAG paddle, it can also lead to significant stress on the gate's transmission system.

One of the primary areas susceptible to damage is the shaft gear 110 or the adjacent spur gear. The shaft gears 110 transfer motion and torque between shafts in the transmission system 100. When an abuse load is applied, the increased torque can cause the shaft gear 110 to wear out prematurely, become misaligned, or even break. This damage can disrupt the smooth operation of the gate, leading to mechanical failures and requiring costly repairs or replacements.

Additionally, the gearbox shafts and internal components are at risk of damage under abuse loads. The gearbox is a basic part of the transmission system, containing gears and shafts that work together to manage the torque and motion of the fare gate 102. Excessive force can cause the shafts to bend, break, or become misaligned, while internal components, such as bearings and gears, can suffer from increased wear and tear. This internal damage can compromise the overall functionality of the gate, leading to operational issues and potential safety hazards.

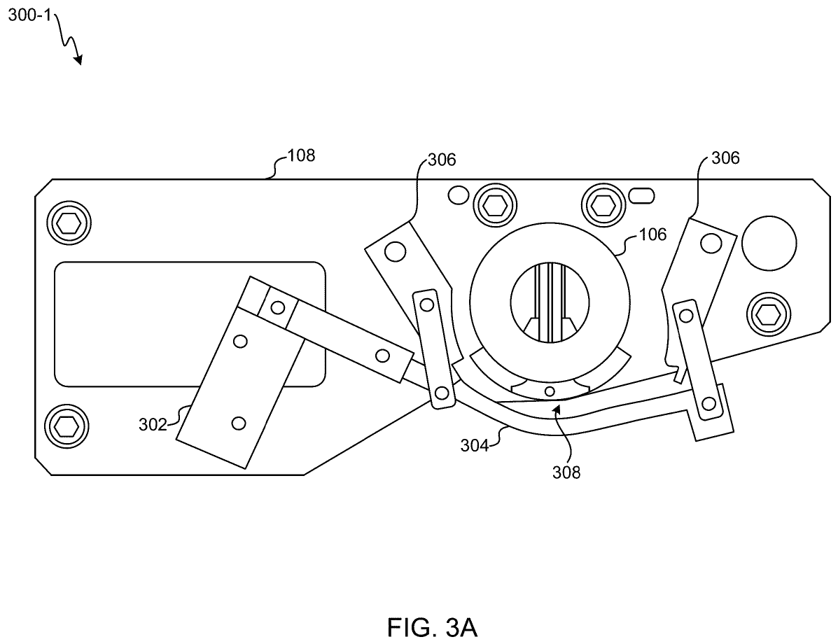

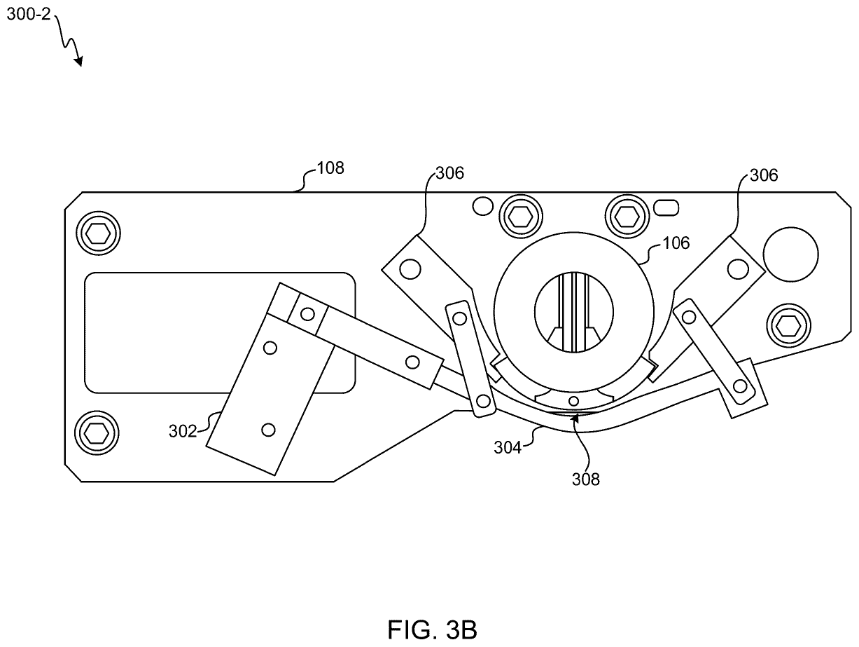

Referring next to FIG. 3A, a locking mechanism integrated at the paddle shaft 106 in an unlocked state 300-1 is shown as an embodiment. The locking mechanism of the protection device 108 locks the paddle shaft 106 in case of fare evasion at the fare gate 102. Additionally, the locking mechanism of the protection device 108 limits torque transmission to the motor and gears of the fare gate 102, thus providing damage control. The protection device 108 includes a solenoid 302, a solenoid lever 304, and shaft arms 306 mounted on a plate of the protection device 108. The plate of the protection device 108 serves as a mounting base for the solenoid 302, solenoid lever 304, and shaft arms 306. The plate of the protection device 108 ensures that components are securely fixed and properly aligned. The plate's design allows for the efficient transfer of mechanical forces generated by the solenoid 302 and solenoid lever 304 to the shaft arms 306, facilitating the locking process.

The solenoid 302 drives the locking mechanism and can fully stop the paddle shaft rotation 106. The solenoid 302 is an electromechanical device that converts electrical energy into mechanical movement. When activated, the solenoid 302 generates a magnetic field that pulls or pushes a solenoid lever 304. In the protection device 108, the solenoid 302 is responsible for initiating the locking mechanism. When the torque on the paddle shaft 106 reaches a preset threshold, the solenoid 302 is energized, causing the solenoid 302 to pull the solenoid lever 304.

The solenoid lever 304 is directly connected to the solenoid 302 and acts as the intermediary between the solenoid 302 and the shaft arms 306. When the solenoid 302 is activated, the solenoid lever 304 moves in response to the solenoid's magnetic field. This movement translates the solenoid's 302 electrical activation into mechanical action, pulling the shaft arms 306 to engage the locking mechanism.

The shaft arms 306 are mechanical components mounted on the paddle shaft 106. The shaft arms 306 are designed to be pulled by the solenoid lever 304 when the solenoid 302 is activated. When pulled, the shaft arms 306 engage with the locking mechanism, preventing the paddle shaft 106 from rotating. This action stops the gate paddle 104 from moving and blocks transmission through the fare gate 102, thereby blocking any unauthorized passage through the fare gate 102. At section 308, the unlocked state 300-1 of the locking mechanism indicates that the paddle shaft 106 is rotating, and the torque applied to the paddle shaft 106 has not met the stopping criterion yet. When the gap shown at section 308 closes, the protection device 108 is activated, and the paddle shaft 106 rotation is stopped.

Referring next to FIG. 3B, a locking mechanism integrated at the paddle shaft 106 in a locked state 300-2 is shown as an embodiment. At section 308, the locked state 300-2 of the locking mechanism indicates that the paddle shaft 106 has stopped rotating because the torque applied to the paddle shaft 106 has met the stopping criterion. The stopping criterion or the preset threshold of the locking mechanism is adjustable and based on the force applied to the gate paddles 104. This limits the amount of torque transferred to the motor and gears of the fare gate 102 when abuse load is applied at the gate paddles 104, thus preventing the internal components from damaging over time.

The locking mechanism is integrated directly into the paddle shaft 106 and operates by pulling the shaft arms 306 connected to the paddle shaft 106 through the action of the solenoid 302. This action is triggered when the torque applied to the paddle shaft 106 reaches a preset threshold. Once the preset threshold is reached, the solenoid 302 activates, pulling the shaft arms 306, and effectively locking the paddle shaft 106 in place. This prevents any further rotation of the gate paddle 104, thereby stopping any unauthorized passage through the fare gate 102. In addition to stopping the rotation of the paddle shaft 106, the locking mechanism also serves to block transmission through the fare gate 102. This ensures that the fare gate 102 remains secure, no damage is done to the internal components, and that fare evasion is successfully prevented. Managing torque transmission at the fare gate 102 increases longevity and efficiency of the transmission system 100. The protection device 108 ensures that the fare gate 102 remains operational and safe, even under conditions of abuse load.

In one embodiment, a transmission device with a protection mechanism uses a locking mechanism that is built into the existing gate transmission system. The transmission device is based on a turnstile principle: the gate paddles 104 unlock when credit is presented and lock when credit is rejected or not presented. The E2 Gate is designed to have predetermined paddle force settings driven by the software and the gear motor output. The protection device 108 uses a single solenoid that drives the locking mechanism, which is capable of fully stopping the rotation of the paddle shaft 106. The locking mechanism is used to transmit torque in a drive system. By locking the paddle shaft 106, rotation of the gate paddles 104 is stopped, and passage through the fare gate 102 is blocked. The amount of torque that the locking mechanism can transmit is adjustable and depends on the amount of force applied at the gate paddles 104. Hence, offering protection to the transmission device.

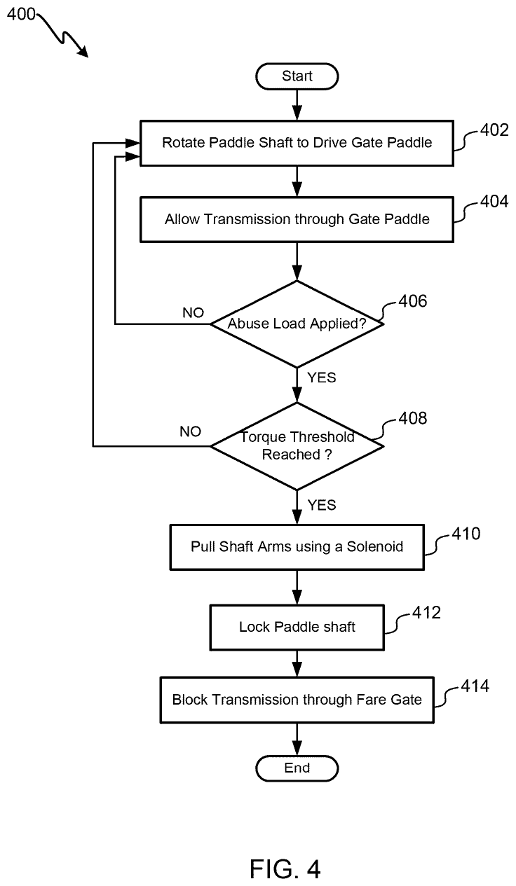

Referring next to FIG. 4, a transmission method 400 with a protection device 108 to enable access and damage control at a fare gate 102 is shown as an embodiment. At block 402, the motor rotates paddle shaft 106 to drive the gate paddles 104 of the fare gate 102. The gate paddle 104 is the physical gate that opens and closes to allow or restrict access. The gate paddle 104 can be in the form of one or more sliding doors, rotating turnstiles, or flaps.

At block 404, the gate paddles 104 are configured to allow transmission through the fare gate 102. Transmission through the fare gate 102 is granted when the gate paddle 104 is rotating, and transmission through the fare gate 102 is blocked when the rotation of the gate paddle 104 is stopped. At block 406, the transmission system 100 checks whether the abuse load is applied at the fare gate or not. The abuse load refers to excessive force or pressure applied to the fare gate 102, which can occur due to intentional misuse, accidental impact, or overcrowding. When such a load is applied to the extended WAG paddle, it can significantly stress the gate's transmission system. When an abuse load is applied at the fare gate 102, the increased torque can cause the shaft gear 110 to wear out prematurely, become misaligned, or even break. This damage can disrupt the smooth operation of the fare gate 102, leading to mechanical failures and requiring costly repairs or replacements.

If the abuse load is not applied, then the transmission system 100 keeps driving the gate paddles 104 at block 402. Otherwise, if the abuse load is applied, then the transmission system 100 checks whether the preset threshold for torque transmission to the motor has been reached or not at block 408. Managing torque transmission at the fare gate 102 increases longevity and efficiency of the transmission system 100.

If the preset threshold has not yet been reached, then transmission through the fare gate 102 is allowed at block 402. On the other hand, if the preset threshold is reached, then the protection device 108 is activated, and the solenoid 302 pulls the shaft arms 306 at block 410. The protection device 108 is activated when the torque applied to the paddle shaft 106 reaches the preset threshold. The protection device 108 ensures that the fare gate 102 remains operational and safe, even under conditions of abuse load. Additionally, the protection device 108 locks the paddle shaft 106 in case of fare evasion at the fare gate 102. The protection device 108 limits torque transmission by locking the paddle shaft 106 when the torque applied to the paddle shaft 106 reaches a preset threshold. The preset threshold of the locking mechanism is adjustable and defined based on the force applied to the gate paddles 104.

At block 412, the solenoid lever 304 coordinated with the shaft arms 306 to lock the paddle shaft 106. This locking action stops the paddle shaft 106 from rotating. As a result, transmission through the fare gate 102 is also blocked at block 414, as the gate paddles 104 are now unable to move. The transmission through the gate paddles 104 is allowed when the power supply to the solenoid 302 is cut off or the abuse load is lifted from the gate paddles 104 of the fare gate 102.

Integrating the protection device 108 with the locking mechanism at the paddle shaft 106 prevents fare evaders from passing through the fare gate 102 without valid credit, reduces revenue loss due to fare evasion, and provides gear motor protection. In one embodiment, the protection device 108 is used for building security, access control systems, such as restricted zones, laboratories, retail, etc. The protection device 108 is further used for crowd management in places where there are high-volume crowds, such as sports events, concerts, and public spaces. The protection device 108 ensures that abusive impacts do not directly affect the motor, thus prolonging the lifespan of gear motors and reducing maintenance costs. The protection device 108 entails no major redesign of the fare gate 102, which means the locking mechanism can be an upgrade kit for the existing products.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A transmission system with a protection device to enable access and damage control at a fare gate, the transmission system comprises:
a motor that rotates a paddle shaft to drive a gate paddle;
the gate paddle operable to allow transmission through the fare gate; and
the protection device to lock the paddle shaft in case of fare evasion at the fare gate, wherein the protection device comprises:
a locking mechanism integrated at the paddle shaft, wherein the locking mechanism is operable to:
pull a plurality of shaft arms of the paddle shaft via a solenoid when torque applied to the paddle shaft reaches a preset threshold;
lock the paddle shaft to stop rotation of the gate paddle; and
block transmission through the fare gate.

2. The transmission system with a protection device to enable access and damage control at a fare gate of claim 1, wherein the gate paddle, when rotated, allows transmission through the fare gate, and blocks transmission through the fare gate, when not in rotation.

3. The transmission system with a protection device to enable access and damage control at a fare gate of claim 1, wherein the gate paddle of a plurality of gate paddles is connected to the paddle shaft of a plurality of paddle shafts to allow transmission at the fare gate based on rotation of the plurality of paddle shafts.

4. The transmission system with a protection device to enable access and damage control at a fare gate of claim 1, wherein the transmission system detects fare evasion when torque applied to the paddle shaft reaches a preset threshold.

5. The transmission system with a protection device to enable access and damage control at a fare gate of claim 1, wherein the protection device is activated when the torque applied to the paddle shaft reaches the preset threshold.

6. The transmission system with a protection device to enable access and damage control at a fare gate of claim 1, wherein the preset threshold is defined based on an amount of force applied on a plurality of gate paddles.

7. The transmission system with a protection device to enable access and damage control at a fare gate of claim 1, wherein the gate paddle allows transmission through the fare gate when power supply to the solenoid is cut off.

8. The transmission system with a protection device to enable access and damage control at a fare gate of claim 1, wherein the locking mechanism limits torque transmission to the motor and a plurality of gears of the fare gate.

9. A transmission method with a protection device to enable access and damage control at a fare gate, the transmission method comprising:
rotating a paddle shaft to drive a gate paddle via a motor;
allowing transmission through the fare gate by operating the gate paddle; and
locking the paddle shaft using the protection device in case of fare evasion at the fare gate, by:
integrating a locking mechanism at the paddle shaft, wherein the locking mechanism is operable to:
pulling a plurality of shaft arms of the paddle shaft via a solenoid when torque applied to the paddle shaft reaches a preset threshold;
locking the paddle shaft to stop rotation of the gate paddle; and
blocking transmission through the fare gate.

10. The transmission method with a protection device to enable access and damage control at a fare gate of claim 9, wherein transmission through the fare gate is allowed while the gate paddle rotates, and transmission through the fare gate is blocked while rotation of the gate paddle is stopped.

11. The transmission method with a protection device to enable access and damage control at a fare gate of claim 9, wherein the gate paddle of a plurality of gate paddles is connected to the paddle shaft of a plurality of paddle shafts to allow transmission at the fare gate based on rotation of the plurality of paddle shafts.

12. The transmission method with a protection device to enable access and damage control at a fare gate of claim 9, wherein the transmission method comprises detecting fare evasion when torque applied to the paddle shaft reaches a preset threshold.

13. The transmission method with a protection device to enable access and damage control at a fare gate of claim 9, wherein the protection device is activated when torque applied to the paddle shaft reaches the preset threshold.

14. The transmission method with a protection device to enable access and damage control at a fare gate of claim 9, wherein the preset threshold of the locking mechanism is defined based on an amount of force applied on a plurality of gate paddles.

15. The transmission method with a protection device to enable access and damage control at a fare gate of claim 9, wherein transmission through the fare gate is allowed when power supply to the solenoid is cut off.

16. The transmission method with a protection device to enable access and damage control at a fare gate of claim 9, wherein the locking mechanism limits torque transmission to the motor and a plurality of gears of the fare gate.

17. A transmission device with a protection mechanism to enable access and damage control at a fare gate, the transmission device comprises:
a motor that rotates a paddle shaft to drive a gate paddle;
the gate paddle operable to allow transmission through the fare gate; and
the protection mechanism to lock the paddle shaft in case of fare evasion at the fare gate, wherein the protection mechanism comprises:
a locking mechanism integrated at the paddle shaft, wherein the locking mechanism is operable to:
pull a plurality of shaft arms of the paddle shaft via a solenoid when torque applied to the paddle shaft reaches a preset threshold;
lock the paddle shaft to stop rotation of the gate paddle; and
block transmission through the fare gate.

18. The transmission device with a protection mechanism to enable access and damage control at a fare gate of claim 17, wherein the preset threshold of the locking mechanism is defined based on an amount of force applied on a plurality of gate paddles.

19. The transmission device with a protection mechanism to enable access and damage control at a fare gate of claim 17, wherein the gate paddle allows transmission through the fare gate when power supply to the solenoid is cut off.

20. The transmission device with a protection mechanism to enable access and damage control at a fare gate of claim 17, wherein the locking mechanism limits torque transmission to a motor and a plurality of gears of the fare gate.
